(19) United States
(12) Patent Application Publication
(10) Pub. No.: US 2006/0114891 A1
(43) Pub. Date: Jun. 1, 2006

(54) Terminal apparatus and control method of the terminal apparatus

(75) Inventors: Yoshihiro Uto, Akishima-shi (JP); Takeshi Horiuchi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/289,304

(22) Filed: Nov. 30, 2005

(30) Foreign Application Priority Data
Nov. 30, 2004 (JP) 2004-346563

(51) Int. Cl. H04L 12/66

(52) U.S. Cl. 370/356; 370/493

(57) ABSTRACT

A terminal apparatus includes: an network interface that is connected to a communication network for transmitting data packets including a voice packet containing voice data; a microphone that receives voice and converts into a voice signal; a converter that converts the voice signal into the voice packet for transmitting through the communication network via the network interface, and converts the voice packet received by the network interface into the voice signal; a speaker that outputs the voice signal converted by the converter; a storage unit that stores volume values each corresponding to a plurality of different operation modes; a detection unit that detects the operation mode; and a control unit that reads the volume value corresponding to the detected operation mode from the storage unit and controlling a signal level of the voice signal output from the speaker based on the read volume value.

### RELATED APPLICATIONS

The present disclosure relates to the subject matter contained in Japanese Patent Application No. 2004-346563 filed on Nov. 30, 2004, which is incorporated herein by reference in its entirety.

### BACKGROUND

1. Field of the Invention

The present invention relates to a terminal apparatus used as a VOIP (Voice Over Internet Protocol) telephone with a personal computer provided with a telecommunication capability, for example, and a control method of the terminal apparatus.

2. Description of the Related Art

In recent years, a network telephone system (VOIP telephone system) for transmitting and receiving an image and voice as packet data bidirectionally through a packet network has begun to come into widespread use. In the VOIP telephone system, an art is proposed wherein a personal computer or a server is provided with a VOIP telecommunication capability for use as a VOIP telephone. The software structure wherein a VOIP telephone application is installed in a general-purpose operating system (OS) is adopted.

In order to share the personal computer between the basic data processing capability as such to execute word processing software, spreadsheet software, E-mail software, and the Internet connection software, and the VOIP telecommunication capability, the same sound output volume is set for both the capabilities. Thus, if the volume is small, the ringing tone from a speaker when an incoming call occurs lessens to a level at which the user cannot hear the ringing. If the volume is set at a level too large, when an incoming call occurs, abruptly a large sound may be produced.

In consideration of the above problem, a technique of setting the optimum volume for each application is proposed. (For example, refer to JP-A-2001-256041)

### SUMMARY

In the technique proposed in JP-A-2001-256041, the volume is automatically set for each of the application software and the telephone ringing volume, the speaker volume, the headset reception volume, and the like in the VOIP telephone application are not set separately. Thus, a technique of automatically setting the volume in response to the use state of the telephone is demanded strongly.

The present invention provides a terminal apparatus shared between a telephone application function and any other application function, the terminal apparatus that can set the volume responsive to the use state when the telephone application function is used, and a control method of the terminal apparatus.

A terminal apparatus includes: an network interface that is connected to a communication network for transmitting data packets including a voice packet containing voice data; a microphone that receives voice and converts into a voice signal; a converter that converts the voice signal into the voice packet for transmitting through the communication network via the network interface, and converts the voice packet received by the network interface into the voice signal; a speaker that outputs the voice signal converted by the converter; a storage unit that stores volume values each corresponding to a plurality of different operation modes; a detection unit that detects the operation mode; and a control unit that reads the volume value corresponding to the detected operation mode from the storage unit and controlling a signal level of the voice signal output from the speaker based on the read volume value.

A method is for controlling a terminal apparatus that is connected to a communication network for transmitting data packets including a voice packet containing voice data. The method includes: converting a voice signal received through a microphone into the voice packet for transmitting through the communication network; converting the voice packet received through the communication network into the voice signal for outputting through a speaker; storing volume values each corresponding to a plurality of different operation modes in a storage unit; detecting the operation mode of the terminal apparatus; reading the volume value corresponding to the detected operation mode from the storage unit; and controlling a signal level of the voice signal output from the speaker based on the read volume value.

### BRIEF DESCRIPTION OF THE DRAWINGS

In the accompanying drawings:

FIG. 1 is a block diagram to show a terminal apparatus according to a first embodiment;

FIG. 2 is a drawing to show an example of data stored in a storage unit in FIG. 1;

FIG. 3 is a flowchart to show a processing procedure of a control unit when an incoming call comes in the first embodiment;

FIG. 4 is a flowchart to show a processing procedure of the control unit to make conversation in the first embodiment;

FIG. 5 is a block diagram to show a terminal apparatus according to a second embodiment;

FIG. 6 is a frequency characteristic drawing of speaker volume applied in the second embodiment;

FIG. 7 is a characteristic drawing to show the relationship between speaker input signal level and speaker volume level applied in the second embodiment;

FIG. 8 is a signal waveform drawing to describe the input/output characteristic of an internal speaker in the second embodiment;

FIG. 9 is a characteristic drawing to show the relationship between speaker volume and input signal in the second embodiment;

FIG. 10 is a characteristic drawing to show the relationship between the amplification factor of an audio amplifier and input signal in the second embodiment; and

FIG. 11 is a characteristic drawing to show an output signal of the internal speaker after ALC in the second embodiment.

### DETAILED DESCRIPTION OF THE EMBODIMENT

Referring now to the accompanying drawings, there are shown preferred embodiments of the invention.

### First Embodiment

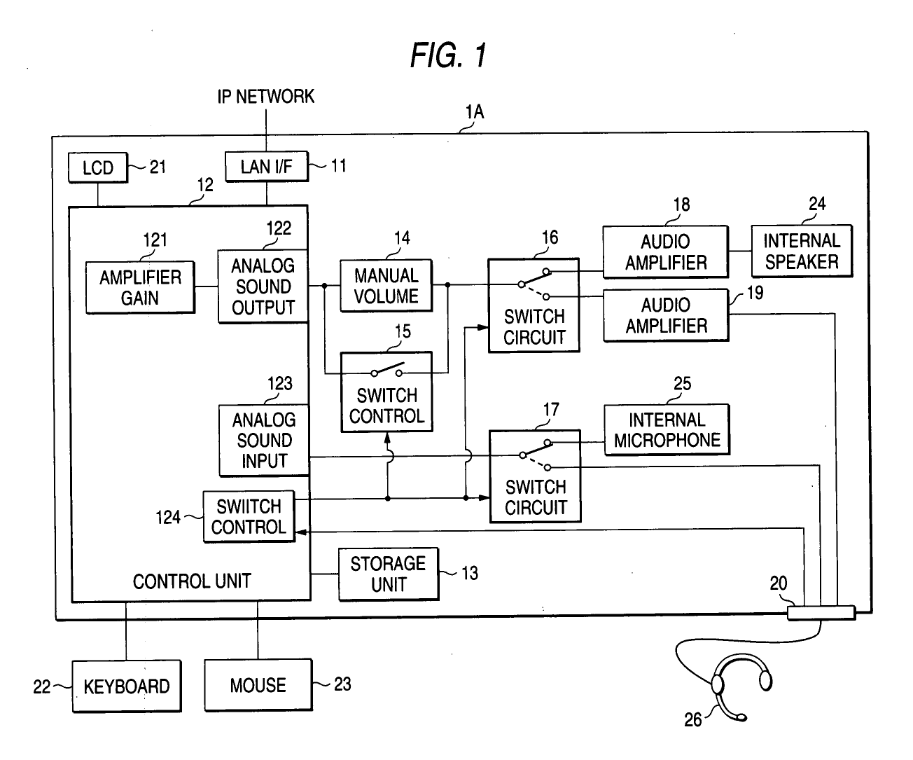

FIG. 1 is a block diagram to show a terminal apparatus according to a first embodiment.

In FIG. 1, numeral 1A denotes a terminal apparatus implemented as a personal computer wherein a data communication application and a VOIP telephone application are installed. The terminal apparatus 1A is connected to an IP network.

The terminal apparatus 1A includes a LAN (Local Area Network) interface (I/F) unit 11, a control unit 12, a storage unit 13 having a memory device and a hard disk drive, a manual volume 14, a bypass unit 15, switch circuits 16 and 17, audio amplifiers 18 and 19, and a headset interface (I/F) unit 20. A display unit (LCD) 21, a keyboard 22, and a mouse 23 are connected to the control unit 12. An internal speaker 24 is connected to the audio amplifier 18 and an internal microphone 25 is connected to the switch circuit 17.

The LAN interface unit 11 performs the interface operation concerning the IP network. This means that the LAN interface unit 11 gives a transmission packet sent from the IP network to the control unit 12. The LAN interface unit 11 transmits a transmission packet given from the control unit 12 to the IP network.

In the embodiment, the LAN interface unit 11 serves as a network interface that is connected to a communication network for transmitting data packets including a voice packet containing voice data.

The control unit 12 converts the transmission packet given from the LAN interface unit 11 into an analog reception voice signal and converts an input transmission voice signal into a transmission packet that can be handled in the IP network and gives the transmission packet to the LAN interface unit 11.

At the speakerphone conversation time, the reception voice signal is supplied through the bypass unit 15 and the switch unit 16 to the audio amplifier 18 and is amplified by the audio amplifier 18 and then is supplied to the internal speaker 24 for playing back the voice signal. The transmission voice signal input through the internal microphone 25 is supplied through the switch circuit 17 to the control unit 12.

In a case where a headset 26 is connected to the headset interface unit 20, the reception voice signal output from the control unit 12 is supplied through the bypass unit 15 and the switch unit 16 to the audio amplifier 19 and is amplified by the audio amplifier 19 and then is output from the headset 26. The transmission voice signal input through the headset 26 is supplied through the switch circuit 17 to the control unit 12.

In the embodiment, the internal microphone 25 serves as a microphone that receives voice and converts into the voice signal. The internal speaker 24 serves as a speaker that outputs the voice signal converted by a converter.

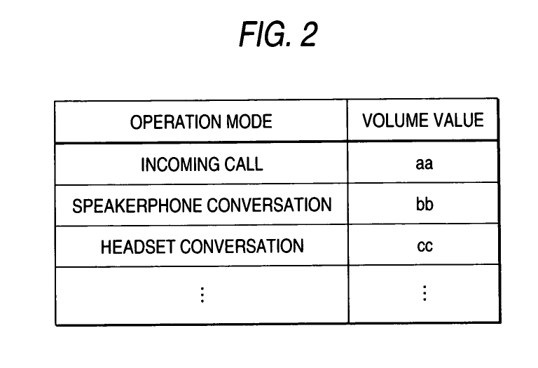

The storage unit 13 stores a table representing the correspondence between each operation mode and the volume value to be set, as shown in FIG. 2. The volume values satisfy the relation of cc<bb<aa, for example.

The headset interface unit 20 inputs the transmission voice signal input through the headset 26 to the control unit 12 through the switch circuit 17 and also supplies the reception voice signal output from the audio amplifier 19 to the headset 26 for outputting the voice signal. If the headset 26 is connected, the headset interface unit 20 sends connection information to the control unit 12.

The control unit 12 includes an amp gain 121, an analog sound output unit 122, an analog sound input unit 123, and a switch control unit 124 by software processing. The amp gain 121 reads the volume value corresponding to the operation mode specified by the switch control unit 124 from the storage unit 13 and adjusts the volume of the reception voice signal in accordance with the volume value.

In the embodiment, the control unit 12 serves as a detection unit that detects the operation mode.

The analog sound output unit 122 outputs the reception voice signal with the volume adjusted by the amp gain 121 to the bypass unit 15. The analog sound input unit 123 inputs the transmission voice signal supplied through the switch circuit 17.

In the embodiment, the analog sound output unit 122 and the analog sound input unit 123 serve as a converter that converts the voice signal into the voice packet for transmitting through the communication network via the network interface, and converts the voice packet received by the network interface into the voice signal.

The switch control unit 124 monitors an incoming call and when an incoming call occurs, causes the amp gain 121 to set the volume corresponding to the incoming call. At the incoming response time, the switch control unit 124 detects whether or not the headset 26 is connected. If the headset 26 is not connected, the switch control unit 124 causes the amp gain 121 to set the volume corresponding to speakerphone conversation, sets the bypass unit 15 to ON, and switches the switch circuits 16 and 17 to the internal speaker 24 and the internal microphone 25. If the headset 26 is connected, the switch control unit 124 causes the amp gain 121 to set the volume corresponding to headset conversation, sets the bypass unit 15 to ON, and switches the switch circuits 16 and 17 to the headset 26.

The keyboard 22 and the mouse 23 are provided for accepting various command entries of the user for the control unit 12. The display unit 21 provides the user with various pieces of information.

Next, the processing operation in the described configuration will be discussed.

First, when the terminal apparatus 1A is started, the control unit 12 displays a volume setting and registration screen on the display unit 21 and requests the user to register the volume through the keyboard 22 and the mouse 23. The control unit 12 determines the result of registration with the keyboard 22 and the mouse 23. If no entries are made, the control unit 12 displays a message for the user to check whether or not the previous registration value may be used. If the previous registration value may be used, the value is used. If registration is made, the control unit 12 reads the registration data and registers the data in the storage unit 13.

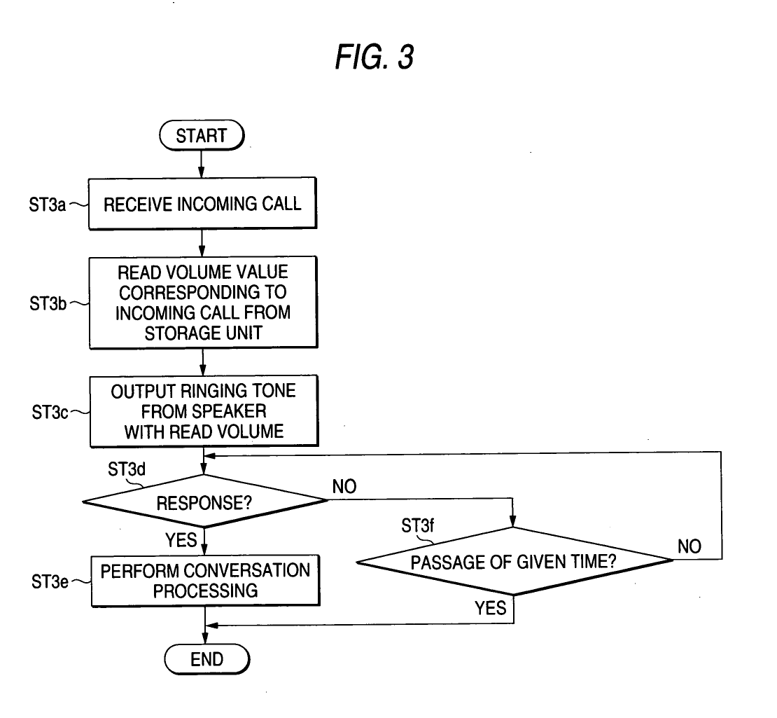

FIG. 3 is a flowchart to show a processing procedure of the control unit 12 when an incoming call comes. In the description to follow, it is assumed that the volume values corresponding to the operation modes are already registered in the storage unit 13.

First, when an incoming call comes through the IP network (step ST3a), the control unit 12 reads the volume value corresponding to the incoming call from the storage unit 13 (step ST3b) and adjusts the volume of the incoming call in accordance with the read volume value and also sets the bypass unit 15 to ON and switches the switch circuit 16 to the audio amplifier 18 for outputting the ringing tone from the internal speaker 24 (ST3c).

The control unit 12 determines whether or not response to the incoming call is to be made (step ST3d). If response to the incoming call is made (YES at step ST3d), the control unit 12 connects the terminal apparatus 1A and the calling terminal apparatus (ST3e).

On the other hand, if response is not made (NO at step ST3d), the control unit 12 determines whether or not response to the incoming call is made within a given time based on a timer (not shown) (step ST3f). If the given time does not pass, the control unit 12 goes to step ST3d; if the given time period passes, the control unit 12 stops sending the ringing tone.

At step ST3c, if the headset 26 is connected to the headset interface unit 20, the ringing tone is forcibly output from the internal speaker 24.

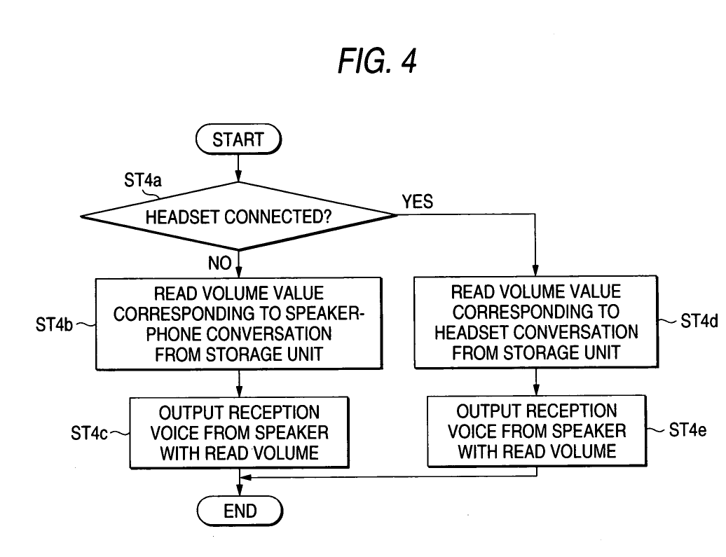

FIG. 4 is a flowchart to show a processing procedure of the control unit 12 to make conversation. Here, it is assumed that a communication link is already established with the communicating party.

At the connection time, the control unit 12 determines whether or not the headset 26 is connected (step ST4a). If the headset 26 is not connected (NO at step ST4a), the control unit 12 reads the volume value corresponding to speakerphone conversation from the storage unit 13 (step ST4b), adjusts the volume of the reception voice signal in accordance with the read volume value and also sets the bypass unit 15 to ON and switches the switch circuit 16 to the audio amplifier 18 for outputting the reception voice signal from the internal speaker 24 (ST4c) On the other hand, if the headset 26 is connected (YES at step ST4a), the control unit 12 reads the volume value corresponding to headset conversation from the storage unit 13 (step ST4d), adjusts the volume of the reception voice signal in accordance with the read volume value and also sets the bypass unit 15 to ON and switches the switch circuit 16 to the audio amplifier 19 for outputting the reception voice signal from the headset 26 (ST4e).

At step ST4a, if change is made from the state in which the headset 26 is connected to the state in which the headset 26 is removed, the control unit 12 reads the volume value corresponding to speakerphone conversation from the storage unit 13, adjusts the volume of the reception voice signal in accordance with the read volume value and also sets the bypass unit 15 to ON and switches the switch circuit 16 to the audio amplifier 18 for outputting the reception voice signal from the internal speaker 24.

As described above, in the first embodiment, information indicating each operation mode of the terminal apparatus 1A and the volume value are registered in association with each other in the storage unit 13, the control unit 12 detects reception of an incoming call and connection or removal of the headset 26 and reads the corresponding volume value based on the detection result, and the volume of the incoming signal or the reception voice signal is automatically adjusted based on the volume value for outputting the signal from the internal speaker 24 or the headset 26.

Therefore, at the incoming time, at the speakerphone conversation time, or at the headset conversation time, the optimum volume can be automatically set regardless of the volume position of the manual volume 14.

In the first embodiment described above, when an incoming call comes, the control unit 12 outputs the ringing tone from the internal speaker 24 at the optimum volume level regardless of whether or not the headset 26 is connected. Thus, if the headset 26 is connected, the user can reliably hear the ringing tone.

### Second Embodiment

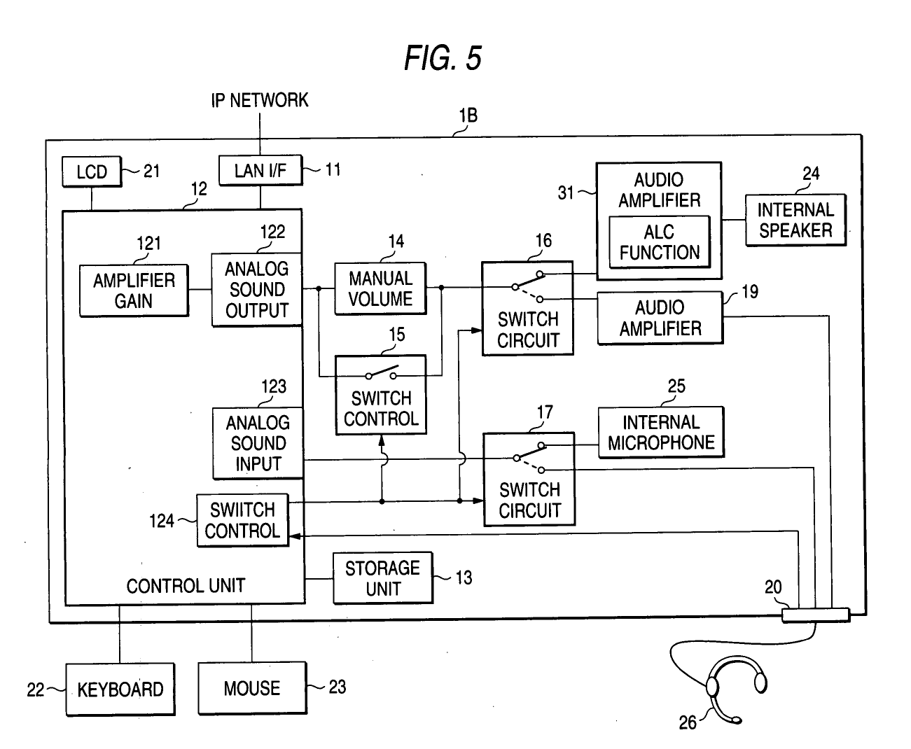

FIG. 5 is a block diagram to show a terminal apparatus according to a second embodiment. Parts identical with those previously described with reference to FIG. 1 are denoted by the same reference numerals in FIG. 5 and will not be discussed again in detail.

That is, the terminal apparatus 1B is provided with an audio amplifier 31 including an ALC (Automatic Level Control) function in place of the audio amplifier 18 described above.

The audio amplifier 31 monitors the signal level of a reception voice signal before the reception voice signal is input to an internal speaker 24. If the signal level of the reception voice signal exceeds a predetermined level, the audio amplifier 31 performs gain control so that the signal level becomes equal to or less than the predetermined level.

Next, the processing operation in the described configuration will be discussed.

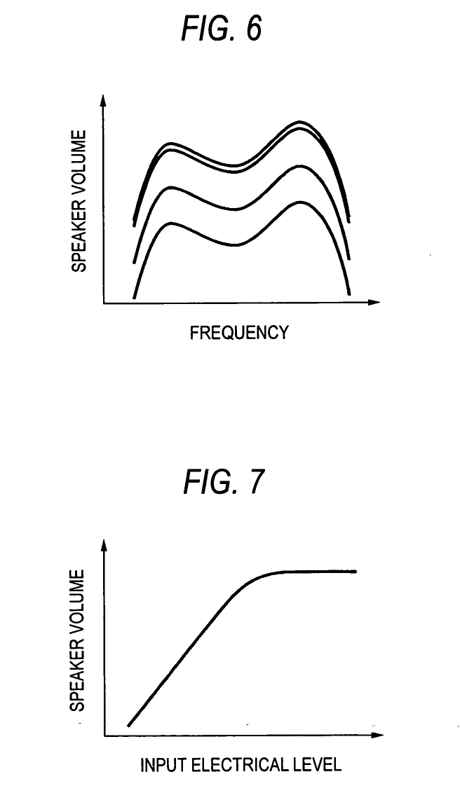

FIG. 6 is a frequency characteristic drawing of speaker volume, and FIG. 7 is a characteristic drawing to show the relationship between speaker input signal level and speaker volume level. In FIG. 6, there are shown a case in which the input signal level is changed in 10-dB steps.

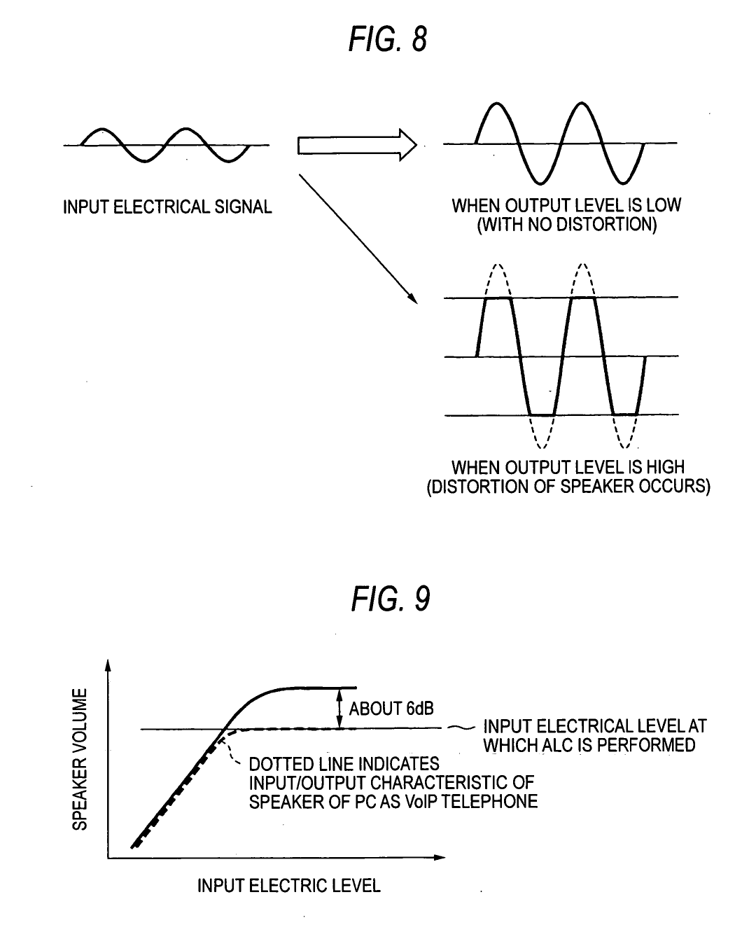

As shown in FIG. 7, when the input signal level is small, linearity is provided, whereas when the input signal level is large, non-linearity is provided. Thus, when the input signal level is small, the internal speaker 24 faithfully converts an electric signal into a sound; however, when the signal level is large, the internal speaker 24 becomes unable to perform conversion to sound at output level because of the characteristic and thus distortion occurs at a large level, as shown in FIG. 8.

In the second embodiment, to eliminate the distortion, the input signal of the internal speaker 24 is subjected to ALC in the audio amplifier 31. The input signal level to be subjected to ALC is set to a value about 6 dB lower than the volume at which output of the internal speaker 24 becomes non-linear and saturation occurs, as shown in FIG. 9.

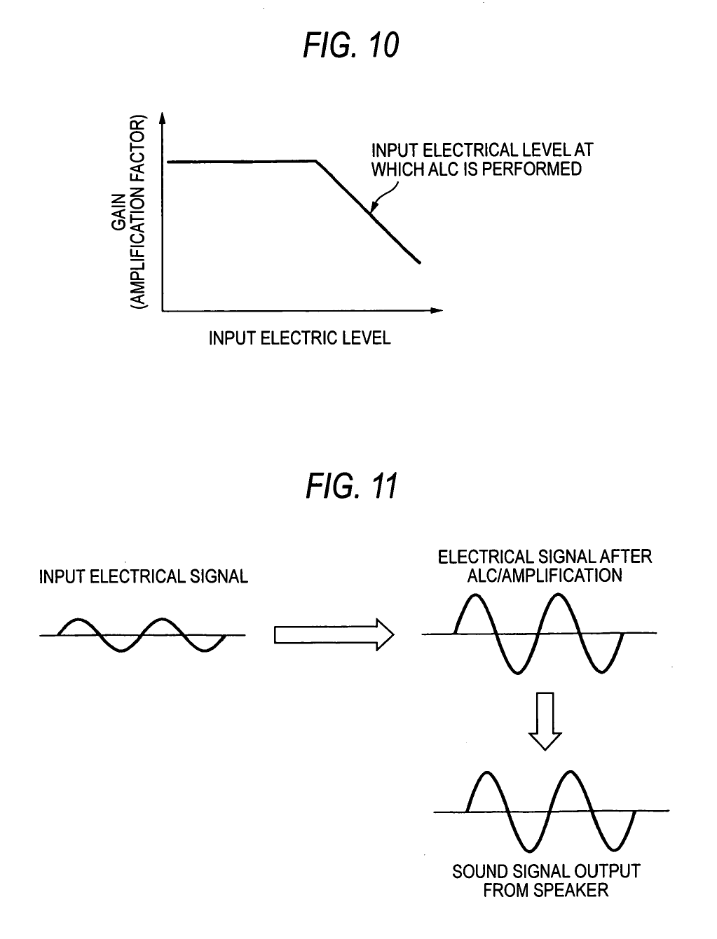

If the input level is small, the audio amplifier 31 holds the gain constant; if the input level is large, the audio amplifier 31 decreases the gain, as shown in FIG. 10. Consequently, if a signal at a large input level is input to the audio amplifier 31, a signal at an output level equal to or larger than the maximum level set in ALC can be prevented from being input to the internal speaker 24, as shown in FIG. 11.

As described above, in the second embodiment, the signal level of the reception voice signal input to the internal speaker 24 is controlled to a lower level than the volume at which output of the internal speaker 24 becomes non-linear and saturation occurs. That is, before sound distortion is caused to occur, if the signal level of the input voice signal is equal to or larger than the predetermined level, the audio amplifier 31 automatically controls the gain, so that distortion in the speaker sound is eliminated.

Therefore, if the communicating party produces a very large sound, conversation can be made in the range in which distortion of the internal speaker 24 does not exist, so that an occurrence of the distortion in sound is prevented.

As described above with reference to the embodiments, information indicating each operation mode of the terminal apparatus and the volume value are registered in a recording medium in association with each other and the operation mode is detected. Accordingly, it is made possible to read the volume value corresponding to the detected operation mode from the recording medium and automatically adjust the voice signal based on the volume value for outputting the voice signal from the speaker. Therefore, at the incoming time or at the speakerphone conversation time, the optimum volume can be automatically set regardless of the position of a manual volume.

The terminal apparatuses according to the embodiments are provided with a detection unit that detects whether or not a headset for playing back the voice signal and inputting the voice signal is connected, and is configured that when the headset is connected, the control unit reads the volume value corresponding to conversation using the headset from the storage unit and controls the signal level of the voice signal based on the volume value.

According to the configuration, in a case where the headset is connected, the optimum volume at the conversation time using the headset can be automatically set without manually setting the volume by the user.

The terminal apparatuses according to the embodiments are configured that when an incoming call is detected with the headset, the control unit reads the volume value corresponding to the incoming call from the storage unit and outputs a ringing tone from the speaker based on the volume value.

According to the configuration, when an incoming call is detected, a ringing tone is output from the speaker at the optimum volume level regardless of whether or not the headset is connected. Thus, in a case where the headset is connected, the user can reliably hear the ringing tone.

The terminal apparatuses according to the embodiments are provided with a gain control unit for monitoring the signal level of the voice signal before the voice signal is input to the speaker and when the signal level of the voice signal exceeds a predetermined level, performing gain control so that the signal level becomes equal to or less than the predetermined level.

According to the configuration, the signal level of the voice signal input to the speaker is controlled to a lower level than the volume at which output of the speaker becomes non-linear and saturation occurs. That is, before sound distortion is caused to occur, if the signal level of the input voice signal is equal to or larger than the predetermined level, the gain is automatically controlled, so that distortion in the speaker sound is eliminated. Therefore, if the communicating party produces a very large sound, conversation can be made in the range in which distortion of the speaker does not exist, so that an occurrence of the distortion in sound is prevented.

As described above in detail, according to the embodiments, there is provided the terminal apparatus shared between the telephone application capability and any other application capability, the terminal apparatus that can set the volume responsive to the use state when the telephone application function is used.

The present invention is not limited to the embodiments described above. For example, in the description of the second embodiment, ALC is performed at the speakerphone conversation time, thereby avoiding distortion of the voice output from the internal speaker, but ALC may also be performed at the headset conversation time, thereby avoiding distortion of the voice output from the headset.

In the description of the embodiments, the volume of the reception voice signal is automatically adjusted by way of example. However, there may be configured to automatically adjust the volume of the transmission voice signal.

In the description of the embodiments, the VOIP telephone application is installed in a personal computer by way of example, but each of the embodiments described above may be applied to an electronic machine for handling a voice signal as well as the personal computer.

The type and the configuration of the terminal apparatus, the types of operation modes at the incoming time, at the speakerphone conversation time, etc., the operation mode detection method, the volume setting procedure, and the like can be modified in various manners without departing from the spirit and scope of the invention.

It is to be understood that the present invention is not limited to the embodiments described above and that the invention can be embodied with the components modified without departing from the spirit and scope of the invention. The present invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A terminal apparatus comprising:
an network interface that is connected to a communication network for transmitting data packets including a voice packet containing voice data;
a microphone that receives voice and converts into a voice signal;
a converter that converts the voice signal into the voice packet for transmitting through the communication network via the network interface, and converts the voice packet received by the network interface into the voice signal;
a speaker that outputs the voice signal converted by the converter;
a storage unit that stores volume values each corresponding to a plurality of different operation modes;
a detection unit that detects the operation mode; and
a control unit that reads the volume value corresponding to the detected operation mode from the storage unit and controlling a signal level of the voice signal output from the speaker based on the read volume value.

2. The terminal apparatus according to claim 1, wherein the detection unit detects whether or not a headset for inputting and outputting the voice signal is connected, and
wherein when the headset is connected, the control unit reads the volume value corresponding to an operation mode for conversation using the headset from the storage unit and controls the signal level of the voice signal output from the speaker based on the read volume value.

3. The terminal apparatus according to claim 2, wherein when an incoming call is detected in a state where the headset being connected, the control unit reads the volume value corresponding to an operation mode for receiving the incoming call from the storage unit and outputs a ringing tone from the speaker based on the read volume value.

4. The terminal apparatus according to claim 1, further comprising a gain control unit that monitors the signal level of the voice signal before the voice signal is input to the speaker,
wherein when the signal level of the voice signal exceeds a predetermined level, the gain control unit performs gain control so that the signal level input to the speaker becomes equal to or less than the predetermined level.

5. The terminal apparatus according to claim 4, wherein when in a state where the headset is connected, the gain control unit monitors the signal level of the voice signal before the voice signal is input to the headset, and
wherein when the signal level of the voice signal exceeds a predetermined level, performs gain control so that the signal level input to the handset becomes equal to or less than the predetermined level.

6. A method for controlling a terminal apparatus that is connected to a communication network for transmitting data packets including a voice packet containing voice data, the method comprising:
converting a voice signal received through a microphone into the voice packet for transmitting through the communication network;
converting the voice packet received through the communication network into the voice signal for outputting through a speaker;
storing volume values each corresponding to a plurality of different operation modes in a storage unit;
detecting the operation mode of the terminal apparatus;
reading the volume value corresponding to the detected operation mode from the storage unit; and
controlling a signal level of the voice signal output from the speaker based on the read volume value.

7. The method according to claim 6, wherein the detecting of the operation mode includes detecting whether or not a headset for inputting and outputting the voice signal is connected, and
wherein when the headset is connected, the volume value corresponding to an operation mode for conversation using the headset is read from the storage unit and the signal level of the voice signal output from the speaker is controlled based on the read volume value.

8. The method according to claim 7, wherein when an incoming call is detected in a state where the headset being connected, the volume value corresponding to an operation mode for receiving the incoming call is read from the storage unit and a ringing tone is output from the speaker based on the read volume value.

9. The method according to claim 6, further comprising monitoring the signal level of the voice signal before the voice signal is input to the speaker,
wherein when the signal level of the voice signal exceeds a predetermined level, a gain control is performed so that the signal level input to the speaker becomes equal to or less than the predetermined level.

10. The method according to claim 9, wherein when in a state where the headset is connected, the signal level of the voice signal is monitored before the voice signal is input to the headset, and
wherein when the signal level of the voice signal exceeds a predetermined level, the gain control is performed so that the signal level input to the handset becomes equal to or less than the predetermined level.
